(19) United States
(12) Patent Application Publication
(10) Pub. No.: US 2025/0334081 A1
(43) Pub. Date: Oct. 30, 2025

(54) FLEX FUEL VEHICLE

(71) Applicant: TOYOTA JIDOSHA KABUSHIKI KAISHA, Toyota-shi (JP)

(72) Inventor: Keita HASHIMOTO, Toyota-shi (JP)

(73) Assignee: TOYOTA JIDOSHA KABUSHIKI KAISHA, Toyota-shi (JP)

(21) Appl. No.: 19/045,849

(22) Filed: Feb. 5, 2025

(30) Foreign Application Priority Data
Apr. 25, 2024 (JP) 2024-071519

(51) Int. Cl. F02D 19/08; F02D 19/06

(52) U.S. Cl. CPC F02D 19/081; F02D 19/0623; F02D 19/0634; F02D 19/0649

(57) ABSTRACT

A flex fuel vehicle includes an engine that operates by burning an alcohol-containing fuel that is a mixture of alcohol and fuel produced from petroleum at any ratio. The flex fuel vehicle transmits an index indicating the concentration of alcohol contained in the alcohol-containing fuel being used to an external equipment outside the flex fuel vehicle.

### CROSS-REFERENCE TO RELATED APPLICATION

This application claims priority to Japanese Patent Application No. 2024-071519 filed on Apr. 25, 2024, incorporated herein by reference in its entirety.

### BACKGROUND

### 1. Technical Field

The present disclosure relates to a flex fuel vehicle.

### 2. Description of Related Art

Japanese Unexamined Patent Application Publication No. 2010-024925 (JP 2010-024925 A) discloses a flex fuel vehicle that is capable of using an alcohol-containing fuel in which gasoline and alcohol are mixed at an optional ratio. Disclosed therein is that an alcohol concentration sensor for directly detecting a concentration of alcohol contained in the fuel is provided in a fuel tank or a fuel pipe. The flex fuel vehicle is capable of detecting an alcohol concentration detection value by the alcohol concentration sensor. The flex fuel vehicle uses the alcohol concentration detection value for air-fuel ratio feedback control.

### SUMMARY

It is known that flex fuel vehicles that travel using an alcohol-containing fuel that contains alcohol contribute to reduction in greenhouse gas emissions. However, flex fuel vehicles can also travel using fuel that does not contain any alcohol whatsoever. Accordingly, when the flex fuel vehicle runs using fuel that does not contain any alcohol whatsoever, there is a problem that reduction in greenhouse gasses cannot be expected.

Means for solving the above problem, and operations and effects thereof, will be described below.

According to an aspect of the present disclosure, there is provided a flex fuel vehicle that is equipped with an internal combustion engine that runs by combustion of an alcohol-containing fuel, obtained by mixing alcohol and a fuel that is produced from petroleum at an optional ratio.

The flex fuel vehicle is configured to transmit an index that indicates a concentration of the alcohol that is contained in the alcohol-containing fuel being used, to external equipment that is outside of the flex fuel vehicle.

According to an aspect of the present disclosure, there is provided a flex fuel vehicle that is equipped with an internal combustion engine that runs by combustion of an alcohol-containing fuel, obtained by mixing alcohol and a fuel that is produced from petroleum at an optional ratio. The flex fuel vehicle is configured to perform
obtaining of an index that indicates a concentration of the alcohol contained in the alcohol-containing fuel being used,
determining of whether the index indicates that the concentration of the alcohol is lower than a threshold value concentration, and
when the index indicates that the concentration of the alcohol is lower than the threshold value concentration, limiting of output of the flex fuel vehicle.

According to an aspect of the present disclosure, there is provided a flex fuel vehicle that is equipped with an internal combustion engine that runs by combustion of an alcohol-containing fuel, obtained by mixing alcohol and a fuel that is produced from petroleum at an optional ratio. The flex fuel vehicle is configured to perform
transmitting of an index that indicates a concentration of the alcohol that is contained in the alcohol-containing fuel being used, to external equipment that is outside of the flex fuel vehicle,
when the external equipment determines that the index indicates that the concentration of the alcohol is lower than a threshold value concentration, receiving, from the external equipment, a restriction command generated by the external equipment, and
when the restriction command is received from the external equipment, restricting of output of the flex fuel vehicle.

The above configuration contributes to realization of reduction of greenhouse gasses through the flex fuel vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a flex fuel vehicle according to a first embodiment that communicates with external equipment;

FIG. 2 is a flowchart illustrating a process performed by the flex fuel vehicle of FIG. 1;

FIG. 3 is a flowchart illustrating a process executed by the external equipment of FIG. 1;

FIG. 4 is a flowchart illustrating a process performed by the flex fuel vehicle of FIG. 1;

FIG. 5 is a diagram showing a flex fuel vehicle according to a second embodiment; and

FIG. 6 is a flowchart illustrating a process executed by the flex fuel vehicle of FIG. 5.

### DETAILED DESCRIPTION OF EMBODIMENTS

### First Embodiment

Hereinafter, a flex fuel vehicle according to a first embodiment will be described with reference to the drawings.

### Configuration of the Flex Fuel Vehicle 100

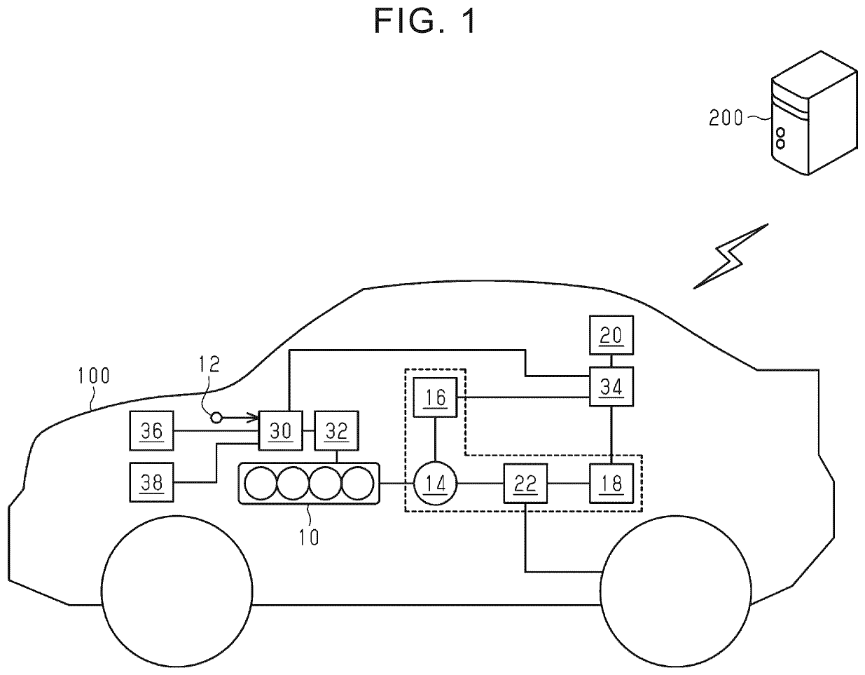

A configuration of the flex fuel vehicle 100 will be described with reference to FIG. 1. The flex fuel vehicle 100 includes an internal combustion engine 10 that operates by burning an alcohol-containing fuel obtained by mixing alcohol and fuel produced from petroleum at an arbitrary ratio. The internal combustion engine 10 is hereinafter referred to as an engine 10. The flex fuel vehicle 100 transmits an index indicating the concentration of alcohol contained in the alcohol-containing fuel being used to the external equipment 200 via the communication device 36. The external equipment 200 is external to the flex fuel vehicle 100. The external equipment 200 is, for example, a server. In the present embodiment, the index is the concentration of alcohol detected by the alcohol concentration sensor 12 provided in the flex fuel vehicle 100.

The flex fuel vehicle 100 includes a first motor generator 16 and a second motor generator 18. Each of the first motor generator 16 and the second motor generator 18 is operable as a driving source for the flex fuel vehicle 100. Further, each of the first motor generator 16 and the second motor generator 18 is operable as a generator that generates electricity by receiving the power of the engine 10.

The flex fuel vehicle 100 also includes a power split mechanism 14 that is a planetary gear mechanism having three rotating elements: a sun gear, a planetary carrier, and a ring gear. The engine 10 is coupled to the power split mechanism 14, and the first motor generator 16 is coupled thereto. The power split mechanism 14 is coupled to the second motor generator 18 via the speed reducer 22. The speed reducer 22 is connected to the drive wheels via a differential mechanism. The power split mechanism 14, the first motor generator 16, the second motor generator 18, and the speed reducer 22 constitute a transmission.

The first motor generator 16 and the second motor generator 18 are electrically connected to the battery 20 via a power control unit 34 (hereinafter referred to as PCU 34). PCU 34 adjusts the amount of electric power supplied from the battery 20 to the first motor generator 16 and the second motor generator 18, and the amount of electric charge from the first motor generator 16 and the second motor generator 18 to the battery 20.

The flex fuel vehicle 100 is equipped with an engine control device 32 which is an electronic control device for controlling the engine 10. Further, the flex fuel vehicle 100 is equipped with a vehicle control device 30 that comprehensively controls the engine control device 32 and PCU 34. The vehicle control device 30 and the engine control device 32 are each configured as a computer unit. The computer unit includes a storage device in which a control program and data are stored. The computer unit further includes a CPU (Central Processing Unit) for executing a program stored in the storage device, and a RAM (Random Access Memory) serving as a working area when CPU executes the program. The storage device is, for example, a ROM (Read Only Memory).

Detection signals such as the amount of depression of the accelerator pedal of the driver and the speed of the flex fuel vehicle 100 are input to the engine control device 32. Then, the vehicle control device 30 calculates a vehicle required power which is a required value of the driving force of the flex fuel vehicle 100 based on the accelerator depression amount and the vehicle speed. Further, the vehicle control device 30 calculates the required engine power, MG1 required torque, and MG2 required torque, respectively, based on the required vehicle power, the amount of electricity stored in the battery 20, and the like. The required engine output is a required value of the engine output. MG1 required torque is a required value of the power running/regenerative torque of the first motor generator 16. MG2 required torque is a required value of the power running/regenerative torque of the second motor generator 18. Then, the engine control device 32 performs output control of the engine 10 in response to the required engine output, and PCU 34 performs torque control of the first motor generator 16 and the second motor generator 18 in response to MG1 required torque and MG2 required torque. As a result, travel control of the flex fuel vehicle 100 is performed.

A detection signal from the alcohol concentration sensor 12 is input to the vehicle control device 30. The alcohol concentration sensor 12 is provided in a fuel tank or a fuel pipe. The alcohol concentration sensor 12 detects the concentration of alcohol contained in the alcohol-containing fuel. The vehicle control device 30 can store the concentration of the alcohol.

The flex fuel vehicles 100 are OBD (Onboard diagnostics) equipped with ports 38. For example, an official can acquire the concentration of the alcohol stored in the vehicle control device 30 via OBD port 38.

### Processing Executed by the Flex Fuel Vehicle 100 and Processing Executed by the External Equipment 200

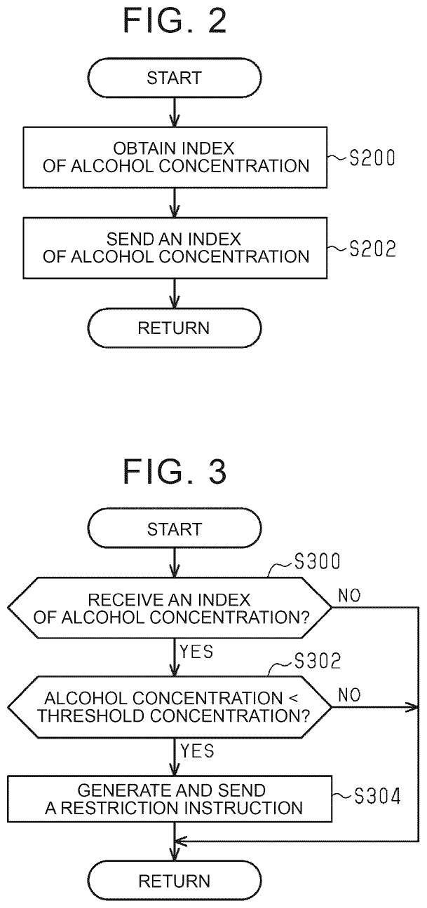

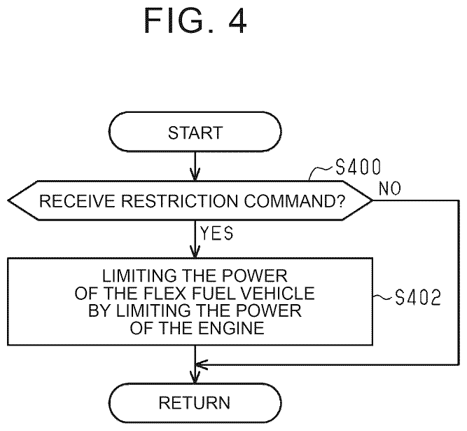

With reference to FIGS. 2 and 4, a process executed by the flex fuel vehicle 100 will be described. Further, a process executed by the external equipment 200 will be described with reference to FIG. 3.

The flex fuel vehicle 100 repeatedly executes the flow illustrated in FIG. 2 while the flex fuel vehicle 100 is in operation. In S200, the flex fuel vehicles 100 acquire an index indicating the level of alcohol contained in the alcohol-containing fuel being used. Specifically, the vehicle control device 30 acquires the concentration of alcohol from the alcohol concentration sensor 12. The flex fuel vehicles 100 then proceed to S202.

In S202, the flex fuel vehicle 100 transmits an index indicating the level of alcohol to an external equipment 200 external to the flex fuel vehicle 100 via the communication device 36.

The external equipment 200 repeatedly executes the flow illustrated in FIG. 3 while the external equipment 200 is in operation. In S300, it is determined whether or not an index indicating the level of alcohol has been received. When an affirmative determination is made in S300 (S300: YES), the external equipment 200 proceeds to S302. In S302, the external equipment 200 determines whether or not the concentration of the alcohol is lower than the threshold concentration based on an index indicating the concentration of the received alcohol. When an affirmative determination is made in S302 (S302: YES), the external equipment 200 proceeds to S304.

In S304, the external equipment 200 transmits a limit command to the flex fuel vehicles 100 that have transmitted the index indicating the concentration of the alcohol. That is, the flex fuel vehicle 100 receives a limit command generated by the external equipment 200 from the external equipment 200 when it is determined that the index indicates that the concentration of alcohol is lower than the threshold concentration by the external equipment 200. The restriction command is a command for restricting the output of the flex fuel vehicle 100.

When a negative determination is made in S300 (S300: NO), the external equipment 200 ends the process of FIG. 3. When a negative determination is made in S302 (S302: NO), the external equipment 200 ends the process of FIG. 3. After completing S304, the external equipment 200 ends the process of FIG. 3.

The flex fuel vehicle 100 repeatedly executes the flow illustrated in FIG. 4 while the flex fuel vehicle 100 is in operation. In S400, the flex fuel vehicles 100 determine whether a limit command has been received from the external equipment 200. When an affirmative determination is made in S400 (S400: YES), the flex fuel vehicle 100 proceeds to S402.

In S402, the flex fuel vehicle 100 limits the output of the flex fuel vehicle 100 by limiting the output of the engine 10. According to S400 and S402, the flex fuel vehicle 100 limits the power of the flex fuel vehicle 100 when a limit command is received from the external equipment 200.

When a negative determination is made in S400 (S400: NO), the flex fuel vehicles 100 terminate the process of FIG. 4. After completing S402, the flex fuel vehicles 100 terminate the process of FIG. 4.

### Operation of this Embodiment

The flex fuel vehicle 100 repeatedly executes the flow illustrated in FIG. 2 while the flex fuel vehicle 100 is in operation. Therefore, the flex fuel vehicle 100 repeatedly transmits an index indicating the concentration of the alcohol to the external equipment 200 during the operation of the flex fuel vehicle 100 (S202). Accordingly, the external equipment 200 receives an index indicating the concentration of alcohol from the flex fuel vehicle 100 during the operation of the flex fuel vehicle 100.

According to S302 and S304, the external equipment 200 transmits a limit command to the flex fuel vehicle 100 when the concentration of the alcohol is lower than the threshold concentration. The flex fuel vehicle 100 limits the output of the flex fuel vehicle 100 when the limit command is received (S400: YES, S402).

### Effect of the 1 Embodiment

(1-1) The flex fuel vehicle 100 includes an engine 10 that operates by burning an alcohol-containing fuel that is a mixture of alcohol and fuel produced from petroleum at any ratio. The flex fuel vehicle 100 transmits an index indicating the concentration of alcohol contained in the alcohol-containing fuel being used to the external equipment 200 outside the flex fuel vehicle 100.

According to the above configuration, the index indicating the concentration of the alcohol contained in the alcohol-containing fuel used in the flex fuel vehicle 100 is transmitted to the external equipment 200. For this reason, for example, the administrator who manages the external equipment 200 can prompt a user who does not use alcohol much as fuel to actively use alcohol as fuel. Therefore, it contributes to the realization of the reduction of the greenhouse gas through the flex fuel vehicle 100.

(1-2) The flex fuel vehicle 100 includes an engine 10 that operates by burning an alcohol-containing fuel that is a mixture of alcohol and fuel produced from petroleum at any ratio. The flex fuel vehicle 100 transmits an index indicating the concentration of alcohol contained in the alcohol-containing fuel being used to the external equipment 200 outside the flex fuel vehicle 100. The flex fuel vehicle 100 receives a limit command generated by the external equipment 200 from the external equipment 200 when it is determined that the index indicates that the concentration of alcohol is lower than the threshold concentration by the external equipment 200. The flex fuel vehicle 100 limits the output of the flex fuel vehicle 100 when a restriction command is received from the external equipment 200.

According to the above configuration, it is possible to impose penalties such as restricting the output of the flex fuel vehicle 100 on a user who does not use alcohol as fuel. This allows the user to be encouraged to use alcohol as fuel.

(1-3) The index is the concentration of alcohol detected by the alcohol concentration sensor 12 provided in the flex fuel vehicle 100.

According to the above configuration, the alcohol concentration itself is used as an index. This is more accurate than, for example, a configuration in which a value correlated with the alcohol concentration based on the relationship between the alcohol-containing fuel and the output of the flex fuel vehicle 100 is used as an index.

(1-4) The flex fuel vehicle 100 limits the output of the flex fuel vehicle 100 by limiting the output of the engine 10.

According to the above configuration, by limiting the output of the engine 10, the output of the vehicle can be limited, and the greenhouse gas can be directly reduced.

### Second Embodiment

Hereinafter, a flex fuel vehicle according to a second embodiment will be described with reference to the drawings. Descriptions of configurations common to the first embodiment and the second embodiment will be omitted.

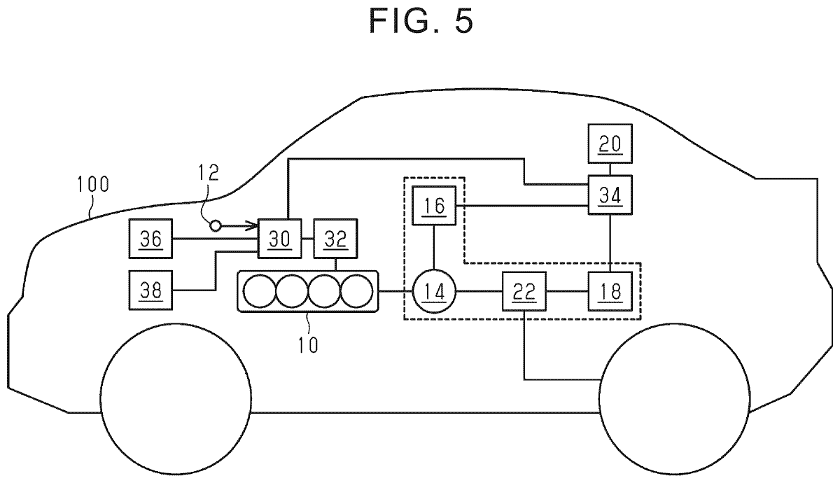

FIG. 5 shows a flex fuel vehicle 100 according to a second embodiment. The flex fuel vehicle 100 according to the second embodiment has the same configuration as the flex fuel vehicle 100 according to the first embodiment. In the first embodiment, the flex fuel vehicle 100 transmits an index indicating the concentration of the alcohol contained in the alcohol-containing fuel being used to the external equipment 200. On the other hand, in the second embodiment, the flex fuel vehicle 100 does not transmit an index indicating the concentration of the alcohol contained in the alcohol-containing fuel being used to the external equipment 200. In the first embodiment, the external equipment 200 determines whether or not the concentration of the alcohol is lower than the threshold concentration based on the index indicating the concentration of the received alcohol. On the other hand, in the second embodiment, the flex fuel vehicle 100 determines whether or not the concentration of the alcohol is lower than the threshold concentration based on the index indicating the concentration of the alcohol.

### Processing Performed by the Flex Fuel Vehicle 100

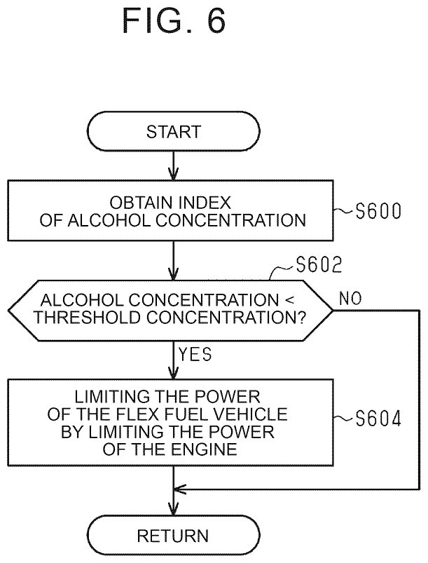

A process executed by the flex fuel vehicle 100 will be described with reference to FIG. 6. The flex fuel vehicle 100 repeatedly executes the flow illustrated in FIG. 6 while the flex fuel vehicle 100 is in operation.

In S600, the flex fuel vehicles 100 acquire an index indicating the level of alcohol contained in the alcohol-containing fuel being used. The flex fuel vehicles 100 then proceed to S602.

In S602, the flex fuel vehicles 100 determine whether the index indicates that the concentration of the alcohol is lower than the threshold concentration. When an affirmative determination is made in S602 (S602: YES), the flex fuel vehicle 100 proceeds to S604.

In S604, the flex fuel vehicle 100 limits the output of the flex fuel vehicle 100 by limiting the output of the engine 10.

When a negative determination is made in S602 (S602: NO), the flex fuel vehicles 100 terminate the process of FIG. 6. After completing S604, the flex fuel vehicles 100 terminate the process of FIG. 6.

### Operation of the Second Embodiment

According to S602 and S604, the flex fuel vehicle 100 limits the power of the flex fuel vehicle 100 if the index indicates that the concentration of the alcohol is less than the threshold concentration.

### Effect of the 2 Embodiment

(2-1) The flex fuel vehicle 100 includes an engine 10 that operates by burning an alcohol-containing fuel that is a mixture of alcohol and fuel produced from petroleum at any ratio. The flex fuel vehicle 100 obtains an index indicating the concentration of alcohol contained in the alcohol-containing fuel being used. The flex fuel vehicle 100 determines whether the index indicates that the concentration of alcohol is lower than a threshold concentration. The flex fuel vehicle 100 limits the output of the flex fuel vehicle 100 if the index indicates that the concentration of alcohol is less than the threshold concentration.

According to the above configuration, it is possible to impose penalties such as restricting the output of the flex fuel vehicle 100 on a user who does not use alcohol as fuel. This allows the user to be encouraged to use alcohol as fuel.

### Example of Change

The following are elements that can be modified with respect to each of the above-described embodiments. The following modifications may be implemented in combination with each other to the extent that they are not technically inconsistent.
In the first embodiment and the second embodiment, the index indicating the concentration of the alcohol contained in the alcohol-containing fuel is the concentration of the detected alcohol. However, this is only an example. The index indicating the concentration of the alcohol may be, for example, a value estimated from the relationship between the fuel injection amount and the output in the flex fuel vehicle 100. The estimated value is a value that correlates with the concentration of alcohol.
In the first embodiment and the second embodiment, the output of the flex fuel vehicle 100 is limited by limiting the output of the engine 10. However, this is only an example. The output of the flex fuel vehicle 100 may be limited, for example, by limiting the outputs of the first motor generator 16 and the second motor generator 18.
With respect to the first and second embodiments, the configuration of the flex fuel vehicle 100 can be changed as appropriate. For example, at least one of the first motor generator 16 and the second motor generator 18 may be omitted.
The processing of FIG. 3 and the processing of FIG. 4 may be omitted for the first embodiment.
In the first embodiment and the second embodiment, each of the vehicle control device 30, the engine control device 32, PCU 34, and the external equipment 200 includes a CPU, RAM and a ROM. CPU performs a software-process. However, this is only an example. For example, the vehicle control device 30 may include dedicated hardware circuitry (e.g., ASIC, etc.) that processes at least a part of the software processes executed in the above-described embodiment. That is, the vehicle control device 30 may have any of the following configurations (a) to (c). (a) The vehicle control device 30 includes a processing device that executes all processes in accordance with a program, and a program storage device such as a ROM that stores a program. That is, the vehicle control device 30 includes a software execution device. (b) The vehicle control device 30 includes a processing device that executes a part of processing according to a program, and a program storage device. Further, the vehicle control device 30 includes a dedicated hardware circuit for executing the remaining processing. (c) The vehicle control device 30 includes a dedicated hardware circuit for executing all processes. The same applies to the engine-control device 32, PCU 34, and the external equipment 200. Here, a plurality of software execution devices and/or dedicated hardware circuits may be provided. That is, the processing may be performed by a processing circuit (processing circuitry) including at least one of a software executing device and a dedicated hardware circuit. The processing circuit may include a plurality of software execution devices and dedicated hardware circuits. A program storage device or computer readable medium includes a storage device that is any available medium that can be accessed by a general purpose or special purpose computer.

What is claimed is:

1. A flex fuel vehicle that is equipped with an internal combustion engine that runs by combustion of an alcohol-containing fuel, obtained by mixing alcohol and a fuel that is produced from petroleum at an optional ratio, wherein the flex fuel vehicle is configured to transmit an index that indicates a concentration of the alcohol that is contained in the alcohol-containing fuel being used, to external equipment that is outside of the flex fuel vehicle.

2. A flex fuel vehicle that is equipped with an internal combustion engine that runs by combustion of an alcohol-containing fuel, obtained by mixing alcohol and a fuel that is produced from petroleum at an optional ratio, wherein the flex fuel vehicle is configured to perform
obtaining of an index that indicates a concentration of the alcohol contained in the alcohol-containing fuel being used,
determining of whether the index indicates that the concentration of the alcohol is lower than a threshold value concentration, and
when the index indicates that the concentration of the alcohol is lower than the threshold value concentration, limiting of output of the flex fuel vehicle.

3. A flex fuel vehicle that is equipped with an internal combustion engine that runs by combustion of an alcohol-containing fuel, obtained by mixing alcohol and a fuel that is produced from petroleum at an optional ratio, wherein the flex fuel vehicle is configured to perform
transmitting of an index that indicates a concentration of the alcohol that is contained in the alcohol-containing fuel being used, to external equipment that is outside of the flex fuel vehicle,
when the external equipment determines that the index indicates that the concentration of the alcohol is lower than a threshold value concentration, receiving, from the external equipment, a restriction command generated by the external equipment, and
when the restriction command is received from the external equipment, restricting of output of the flex fuel vehicle.

4. The flex fuel vehicle according to claim 1, wherein the index is a concentration of the alcohol that is detected by an alcohol concentration sensor that is provided in the flex fuel vehicle.

5. The flex fuel vehicle according to claim 2, wherein the index is a concentration of the alcohol that is detected by an alcohol concentration sensor that is provided in the flex fuel vehicle.

6. The flex fuel vehicle according to claim 3, wherein the index is a concentration of the alcohol that is detected by an alcohol concentration sensor that is provided in the flex fuel vehicle.

7. The flex fuel vehicle according to claim 2, wherein the output of the flex fuel vehicle is restricted by restricting output of the internal combustion engine.

8. The flex fuel vehicle according to claim 3, wherein the output of the flex fuel vehicle is restricted by restricting output of the internal combustion engine.
